(19) United States
(12) Patent Application Publication
(10) Pub. No.: US 2008/0200193 A1
(43) Pub. Date: Aug. 21, 2008

(54) Method and Apparatus for Sending Message Using Information Search Input Field

(76) Inventor: Young-Seok Han, Gyeonggi-do (KR)

Correspondence Address: MCDERMOTT WILL & EMERY LLP, 600 13TH STREET, N.W., WASHINGTON, DC, 20005-3096, US

(21) Appl. No.: 11/992,101

(22) PCT Filed: Jul. 31, 2006
(86) PCT No.: PCT/KR2006/003007

§ 371 Date: Mar. 14, 2008

(30) Foreign Application Priority Data
Sep. 16, 2005 (KR) 10-2005-0086696

(51) Int. Cl. H04Q 7/20

(52) U.S. Cl. 455/466

(57) ABSTRACT

A method and apparatus for transmitting a message, which can determine whether a text is a search term or a message expression when a sender inputs a text into an information query input field, and transmit a message to a receiver when the text is determined as the message expression, is provided. A message transmission method includes: receiving a text which a sender has inputted into an information query input field; determining whether the text is a search term or a message expression; determining a receiver of the message when the text is determined as the message expression, the message expression comprising the message; and transmitting the message to the receiver.

### TECHNICAL FIELD

The present invention relates to a method of transmitting a message, and more particularly, to a method and apparatus for transmitting a message, which can determine whether a text is a search term or a message expression when a sender inputs a text into an information query input field, and transmit a message to a receiver when the text is determined as the message expression.

### BACKGROUND ART

Due to developments of information communication technologies, a sender can transmit a message to a receiver via a user terminal of the sender. As an example, when the sender transmits a Short Message Service (SMS) message to a mobile communication terminal of the receiver, the sender accesses a webpage in the sender's user terminal, and inputs a message into a message input window on the webpage. Here, the webpage interoperates with an SMS server. Also, the sender inputs a mobile communication terminal number of the receiver and selects a transmission method of the message. In this case, the message is transmitted to the SMS server and then the mobile communication terminal of the sender.

Also, when the sender accesses a webpage which interoperates with an email service server in the sender's user terminal, and inputs an email address of the receiver, the email service server transmits the message to the email of the receiver.

As described above, various types of methods have been developed so that a sender can transmit a message to a receiver in a user terminal However, the sender must select a single method from the various types of methods, access a server corresponding to the selected method, and input the message into the server.

Specifically, the sender may select a service from a plurality of services, such as an email, a messenger, an SMS message transmission service, and the like, and transmit a message to the receiver via the selected service. However, when using a service as described above, the sender must access a web server which provides a corresponding service. Also, it is impossible to simultaneously transmit the message using two or more services.

Also, even when the sender desires to transmit a message to the receiver while utilizing another service, for example, an information search service, the sender must access another server corresponding to the information search service to transmit the message.

As described above, according to the conventional art, although an information search service and a message transmission service are services which users frequently utilize, separate interfaces must be utilized. Specifically, the user must utilize an information search interface to search for information, and utilize a message transmission interface to transmit a message.

### DISCLOSURE OF INVENTION

### Technical Goals

The present invention provides a message transmission method and apparatus which can transmit a message by inputting a message expression into an information query input field associated with a program which is installed in a user terminal, or a webpage which is provided by a predetermined web server.

The present invention also provides a message transmission method and apparatus which can transmit a message via various types of services without accessing a plurality of web pages or executing a plurality of programs.

The present invention also provides a message transmission method and apparatus which can designate a group and transmit a message in such a manner that a sender stores a receiver expression in association with a plurality of destination addresses, and also can designate a group and transmit a message without restrict to a type of destination address.

The present invention also provides a message transmission method and apparatus which can identify a destination address and transmit a message to a receiver, even when a sender inputs a message expression, including the destination address, into an information query input field.

### Technical Solutions

According to an aspect of the present invention, there is provided a method of transmitting a message, the method including: receiving a text which a sender has inputted into an information query input field; determining whether the text is a search term or a message expression; determining a receiver of the message when the text is determined as the message expression, the message expression comprising the message; and transmitting the message to the receiver.

According to another aspect of the present invention, there is provided an apparatus for transmitting a message, the apparatus including: a message determination module receiving a text which a sender has inputted into an information query input field, and determining whether the text is a search term or a message expression; a receiver determination module determining a receiver of the message when the text is determined as the message expression, the message expression comprising the message; and a transmission module transmitting the message to the receiver.

### BRIEF DESCRIPTION OF DRAWINGS

FIG. 1 is a flowchart illustrating a method of transmitting a message according to an exemplary embodiment of the present invention;

FIG. 2 is a diagram illustrating an information query input field where a text is inputted according to an exemplary embodiment of the present invention;

FIG. 3 is a diagram illustrating an example of a database which is included in a message transmission apparatus according to an exemplary embodiment of the present invention;

FIG. 4 is a diagram illustrating an information query input field where a text is inputted according to another exemplary embodiment of the present invention; and

FIG. 5 is a block diagram illustrating a configuration of a message transmission apparatus according to an exemplary embodiment of the present invention.

### BEST MODE FOR CARRYING OUT THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

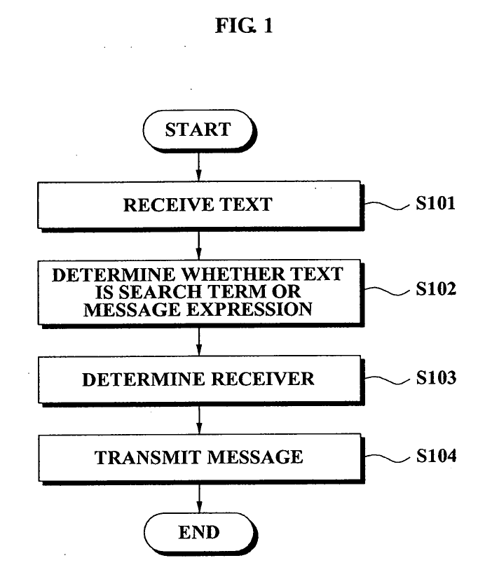

FIG. 1 is a flowchart illustrating a method of transmitting a message according to an exemplary embodiment of the present invention. A message transmission process will be described with reference to FIG. 1.

In operation S101, a message transmission apparatus according to the present invention receives a text which a sender has inputted into an information query input field. Here, the information query input field is any one of an input window for inputting a text on a webpage provided by a predetermined server, and an input window associated with a program which is installed in the sender's user terminal.

The information query input field includes any one of a field for inputting a search term on a webpage provided by a search server, an address input window of a web browser, an address search input window of the program which is installed in the user terminal, and the like.

Also, the user terminal used throughout the present specification is a general concept of a terminal that has a calculation ability by including a microprocessor and a communication module such as, a Code Division Multiplex Access (CDMA) module, a Bluetooth module, an Infrared Data Association (IrDA), a wired/wireless local area network (LAN) card, such as those included in a personal digital assistant (PDA), a smart phone, a handheld personal computer (PC), a mobile phone, an MP3 player, and the like.

In operation S102, the message transmission apparatus determines whether the text is a search term or a message expression. In this case, when the text satisfies a predetermined message expression format, the text may be determined as the message expression.

In the present invention, the message expression designates a text which is determined to include a message to be transmitted from the message transmission apparatus to a receiver according to a predetermined rule. When the text, which is inputted into the information query input field, is determined as the message expression, the message transmission apparatus transmits the message to the receiver.

The message expression includes a message which the sender desires to transmit to the receiver. Also, the message expression includes a receiver expression or a destination address for identifying the receiver. The receiver expression consists of characters or symbols, and is utilized for identifying the receiver of the message. Also, in addition to characters or symbols, various forms, for example, a name (e.g., Honggildong, Dr. Kim), Korean.Korean (e.g., [symbol] ), a Universal Resource Locator (URL), an Internet Protocol (IP) address, a domain name, and the like, may be utilized. The destination address, such as the receiver's telephone number, email address, and the like, may be utilized for the receiver expression.

The predetermined message expression format may be variously applicable by considering the user's convenience. As an example, when the text includes a predetermined delimiter expression, the text may be determined as the message expression. Specifically, when the text includes the delimiter expression, for example, “→”, the text may be determined as the message expression.

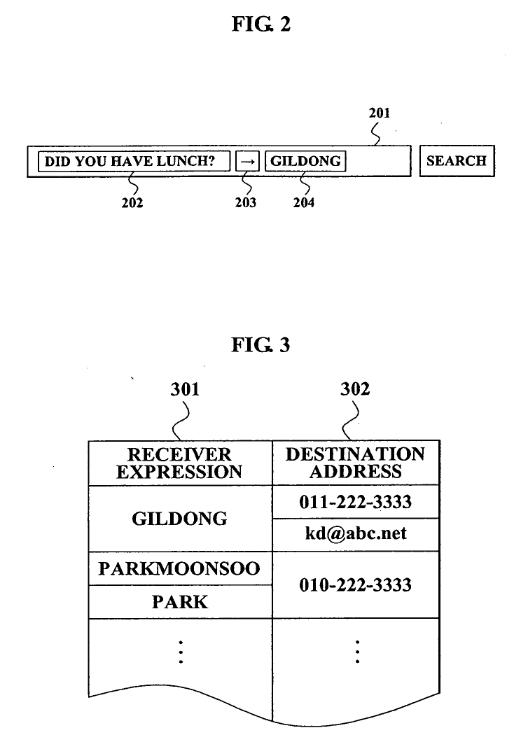

FIG. 2 is a diagram illustrating an information query input field where a text is inputted according to an exemplary embodiment of the present invention. Referring to FIG. 2, a sender may input a text “did you have lunch?→gildong” in a field 201 for inputting a search term on a webpage which is provided by a predetermined search server. When a receiver expression is a URL, a text, for example, “how are you?→www.samsung.com/kdhong”, may be utilized. Also, when the receiver expression is a domain name, a text, for example, “when do you edit your homepage?→www.daum.net”, may be utilized.

The message transmission apparatus receives the text, and determines the text as a message expression, since the text includes “→” 203 corresponding to the delimiter expression.

Here, the message expression includes “did you have lunch?” 202 corresponding to a message, “→” 203 corresponding to the delimiter expression, and “gildong” 204 corresponding to the receiver expression.

In operation S103, the message transmission apparatus determines a receiver of the message when the text is determined as the message expression. Here, the receiver is determined from a destination address or the receiver expression which is included in the message expression. According to an exemplary embodiment of the present invention, assuming that the received text corresponds to the message expression, receiver information is extracted from the received text according to a predetermined rule, and the message included in the text is transmitted to the receiver. As an example, a rule of extracting predetermined bytes, as receiver information, from a latter portion of the received text, with the assumption that the received text corresponds to the message expression, may be utilized. In this case, the receiver information is information for transmitting the message to the receiver, and includes the receiver expression, the destination address, and the like.

Also, the message transmission apparatus maintains a database to determine the destination address corresponding to the receiver expression which is included in the message expression.

FIG. 3 is a diagram illustrating an example of a database which is included in a message transmission apparatus according to an exemplary embodiment of the present invention. Referring to FIG. 3, the database includes a receiver expression 301 and a destination address 302.

The receiver expression 301 is for identifying a receiver from a message expression.

The destination address 302 is for transmitting a message to the receiver. Also, the destination address 302 may include at least one of a device number of a mobile communication terminal, a telephone number, a wireless broadband Internet (WiBro) number, and an email address, an Internet Protocol version 4 (IPv4) address, an IPv6 address, and a messenger user name.

Also, the database may maintain a plurality of destination addresses 302 in association with the receiver expression 301.

As an example, the database may maintain a device number of a mobile communication terminal, “011-222-3333”, and an email address “kd@abc.com” as destination addresses corresponding to receiver expression “gildong”.

Conversely, the database may maintain a plurality of receiver expressions 301 in association with the destination address 302. As an example, the database may maintain various types of receiver expressions, such as, “parkmoonsoo”, “park”, and the like, in association with the destination address 302, “010-222-3333”. In this case, the sender may select one of the plurality of receiver expressions and transmit the message via the selected receiver expression.

The message transmission apparatus identifies the receiver expression 301 from the received text, and reads the destination address 302 associated with the receiver expression 301 by referring to the database.

As an example, when the text of FIG. 2 is inputted, the message transmission apparatus identifies “gildong” 204 corresponding to the receiver expression 301, and reads “011-222-3333” and “kd@abc.com” corresponding to the destination address 302 associated with the receiver expression “gildong”, by referring to the database.

In operation S104, the message transmission apparatus transmits the message to the receiver.

In this case, the message transmission apparatus determines a type of the destination address, and transmits the message to a predetermined server associated with the destination address according to the form of the destination address. According to an exemplary embodiment of the present invention, a different server may be constructed for the form of the destination address. Also, a single server may provide a service for a plurality of types of destination addresses. Specifically, when using a domain name, a corresponding server may be identified by partially using the domain name. As an example, in the case of “how are you?→honggildong.suwonuni”, the message and/or the destination address may be transmitted to a server corresponding to The University of Suwon. Also, in the case of “how are you?→honggildong.koreauni”, the message and/or the destination address may be transmitted to a server corresponding to Korea University.

As described above, the type of the destination address may include at least one of a device number of a mobile communication terminal, a telephone number, a WiBro number, and an email address and a messenger user name. Thus, the message transmission apparatus transmits the message to a server associated with the destination address according to the type of the destination address.

As an example, when the destination address is a device number of a mobile communication terminal, the message transmission apparatus transmits a message to an SMS server which processes an SMS message of the mobile communication terminal. Also, when the destination address is an email address, the message transmission apparatus transmits the message to an email service server which provides an email service. Information about a communication with a server, which is associated with the destination address, may be pre-designated in the message transmission apparatus.

As an example, when the text of FIG. 2 is inputted, the message transmission apparatus identifies “gildong” 204 corresponding to the receiver expression 301, and reads “011-222-333” and “kd@abc.com” corresponding to the destination address 302 associated with the receiver expression “gildong” 204, by referring to the database, and determines the types of the destination addresses, “011 -222-3333” and “kd@abc.com”.

In this case, the destination address “011-222-3333” is determined as the device number of the mobile communication terminal, and thus, the message transmission apparatus transmits the message “did you have lunch?” 202 and the destination address “011-222-3333” to an SMS server. The SMS server transmits the message “did you have lunch?” 202 to the mobile communication terminal corresponding to the destination address “011-222-3333”.

Also, the destination address “kd@abc.com” is determined as the email address, and thus, the message transmission apparatus transmits the message “did you have lunch?” 202 and the destination address “kd@abc.com” to an email service server. The email service server transmits the message “did you have lunch” 202 to the email address of the destination address “kd@abc.com”.

As described above, according to the present invention, when a sender desires to transmit a message to a receiver while using a program which is installed in a user terminal or a webpage which is provided by a predetermined server, the sender may transmit the message to the receiver by only inputting a message expression into an input window which is associated with the program installed in the user terminal or the webpage. Thus, the sender is not particularly required to access the webpage or to execute a program.

Also, according to the present invention, it is possible to simultaneously transmit a message to a plurality of destination addresses corresponding to a receiver expression. Thus, an effect of transmitting a message via various types of paths, while not accessing a plurality of web pages or executing a plurality of programs, may be acquired.

Specifically, when utilizing an existing message transmission service, a sender must access a webpage of providing an email service, a webpage of providing an SMS transmission service to a mobile communication terminal, and a webpage of providing a messenger service, or must execute corresponding programs respectively, so as to transmit the message via email, the mobile communication terminal, and the messenger service. However, according to the present invention, it is possible to simultaneously transmit the message to a sender's email, mobile communication terminal, and messenger by simply inputting the message expression into an information query input field.

Also, a receiver expression may be associated with a plurality of destination addresses. Thus, according to the present invention, it is possible to designate a group and transmit a message by storing the receiver expression in association with the plurality of destination addresses. Also, according to the present invention, since the destination address may be designated into various types of formats, the sender may designate a group and transmit a message irrespective of the types of the destination addresses.

As an example, the sender may transmit a message to a plurality of destination addresses, irrespective of the types of destination addresses, by inputting the destination addresses “011-444-5555”, “017-555-6666”, “mh1@muhann.com”, “mh2@muhann.com”, and the like, into receiver expression “muhann”.

According to exemplary embodiments, the message expression of the present invention may include the destination address, not the receiver expression. In this case, the message transmission apparatus identifies the destination address from the message expression, and transmit a message to the destination address.

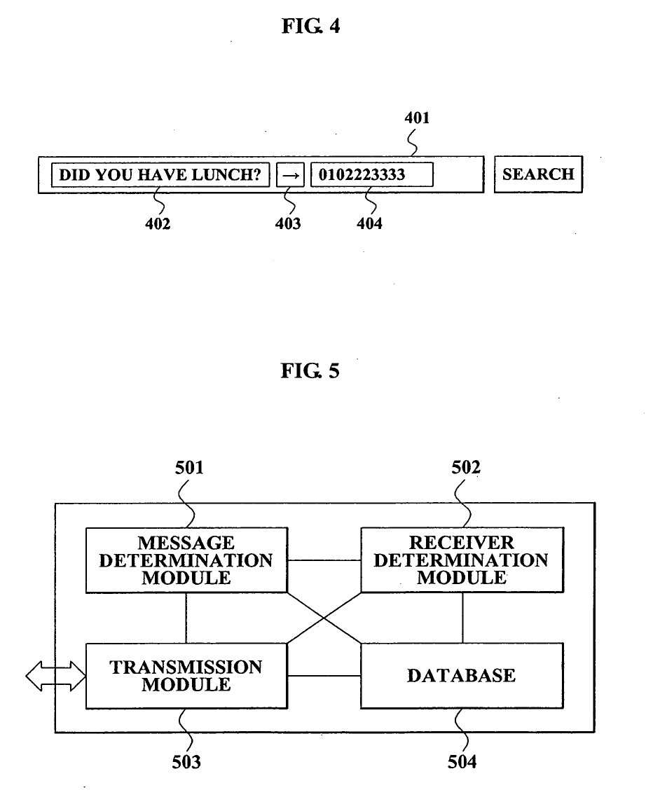

FIG. 4 is a diagram illustrating an information query input field where a text is inputted according to another exemplary embodiment of the present invention. Referring to FIG. 4, a sender may input a text “did you have lunch?→0102223333” into a field 401 for inputting a search term on a webpage provided by a predetermined search server.

In this instance, the message transmission apparatus identifies “0102223333” 403 corresponding to the destination address from the message expression”, and transmits a message “did you have lunch?” 402 to the identified destination address “0102223333” 403. In the above-described example, the message transmission apparatus determines the destination address “0102223333” 403 as a device number of a mobile communication terminal, and transmits the message “did you have lunch?” 202 and the destination address “0102223333” 403 to an SMS server. The SMS server transmits the message to a receiver by transmitting the message “did you have lunch?” 402 to the mobile communication terminal corresponding to the destination address “0102223333” 403.

As described above, according to the present invention, even when a sender inputs a message expression including a destination address into an information query input field, it is possible to identify the destination address from the message expression from the message expression and transmit a message to a receiver.

When the text, which is inputted into the information query input field, is determined to not be the message expression in operation S102 of FIG. 1, the message transmission apparatus may provide the sender with an execution result of the program or the server associated with the information query input field, without performing any operation.

As an example, when the inputted text is determined as not a message expression, and a search server is associated with the information query input field, the search server determines the inputted text as a search term, and provides the sender with a search result corresponding to the search term. Also, according to exemplary embodiments, with the assumption that the inputted text is a message expression, when an operation of extracting a text from receiver information and transmitting a message to a receiver was performed, but the message transmission failed, the search server may determine the inputted text as a search term, and provide the sender with a search result corresponding to the search term.

The message transmission method according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

FIG. 5 is a block diagram illustrating a configuration of a message transmission apparatus according to an exemplary embodiment of the present invention. Referring to FIG. 5, the message transmission apparatus includes a message determination module 501, a receiver determination module 502, a transmission module 503, and a database 504.

The message determination module 501 receives a text which a sender has inputted into an information query input field, and determines whether the text is a search term or a message expression. As described above, when the text satisfies a predetermined message expression format, the message determination module 501 may determine the text as the message expression.

The receiver determination module 502 determines a receiver of the message when the text is determined as the message expression. The receiver of the message may be determined by identifying a receiver expression or a destination address which is included in the message expression. In this case, the destination address corresponding to the receiver expression is read by referring to the database 504.

The transmission module 503 transmits the message to the receiver. The transmission module 503 identifies a receiver expression which is included in the message expression, reads the destination address associated with the receiver expression by referring to the database 504, and transmits the message to the read destination address.

Also, the transmission module 503 may immediately identify the destination address from the message, and transmit the message to the identified destination address.

In this case, the transmission module 503 determines a form of the destination address, and transmits the message to a predetermined server associated with the destination address according to the form of the destination address.

The database 504 maintains at least one receiver expression and a destination address corresponding to the at least one receiver expression in association with the receiver. The database 504 has been described above in detail with reference to FIG. 3.

A message transmission apparatus according to the present invention has been described above, and technical descriptions, which have been described with the above-described exemplary embodiments, may be applicable to the message transmission apparatus of FIG. 5. Thus, further detailed description related thereto will be omitted.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

### INDUSTRIAL APPLICABILITY

According to the present invention, while using a webpage which is provided by a predetermined server, or a program which is installed in a user terminal, a sender may transmit a desired message to a receiver by simply inputting a message expression into an input window which is associated with the program or the webpage. Accordingly, the sender is not required to access the particular webpage or execute the particular program for a specific transmission method.

Also, according to the present invention, it is possible to simultaneously transmit a message to a plurality of destination addresses corresponding to a receiver expression. Accordingly, a sender may transmit a message via various types of services without accessing a plurality of web pages or executing a plurality of programs.

Also, according to the present invention, it is possible to designate a group and transmit a message in such a manner that a sender stores a receiver expression in association with a plurality of destination addresses. Also, according to the present invention, it is possible to designate a group and transmit a message without restrict to a type of destination address.

Also, according to the present invention, it is possible to identify a destination address and transmit a message to a receiver, even when a sender inputs a message expression, including the destination address, into an information query input field.

1. A method of transmitting a message, the method comprising:
receiving a text which a sender has inputted into an information query input field;
determining whether the text is a search term or a message expression;
determining a receiver of the message when the text is determined as the message expression, the message expression comprising the message; and
transmitting the message to the receiver.

2. The method of claim 1, wherein the information query input field is any one of a field for inputting the search term on a webpage provided by a search server, an address input window of a web browser, and an input window associated with a program which is installed in a user terminal of the sender.

3. The method of claim 1, wherein the determining whether the text is a search term or a message expression determines the text as the message expression when the text satisfies a predetermined message expression format.

4. The method of claim 1, further comprising:
maintaining a database which stores at least one receiver expression and a destination address corresponding to the at least one receiver expression in association with the receiver,
wherein the transmitting comprises:
identifying a receiver expression which is included in the message expression;
reading the destination address associated with the receiver expression by referring to the database; and
transmitting the message to the read destination address.

5. The method of claim 4, wherein the transmitting comprises:
determining a type of the destination address; and
transmitting the message to a predetermined server associated with the destination address according to the type of the destination address.

6. The method of claim 4, wherein:
a plurality of destination addresses are associated with the receiver expression, and
the transmitting transmits the message to all of the plurality of read destination addresses.

7. The method of claim 4, wherein a plurality of receiver expressions are associated with the destination address.

8. The method of claim 1, wherein the transmitting comprises:
identifying a destination address which is included in the message expression; and
transmitting the message to the identified destination address.

9. The method of claim 8, wherein the transmitting comprises:
determining a type of the destination address; and
transmitting the message to a predetermined server associated with the destination address according to the type of the destination address.

10. The method of claim 4 or 9, wherein the type of the destination address includes at least one of a device number of a mobile communication terminal, a telephone number, a wireless broadband Internet (WiBro) number, an email address, and a messenger user name.

11. A method of transmitting a message, the method comprising:
receiving a text which a sender has inputted into an information query input field;
extracting receiver information from the text according to a predetermined rule; and
transmitting a message, which is included in the text, to the receiver.

12. A computer-readable recording medium storing a program for implementing the method according to any one of claims 1 through 11.

13. An apparatus for transmitting a message, the apparatus comprising:
a message determination module receiving a text which a sender has inputted into an information query input field, and determining whether the text is a search term or a message expression;
a receiver determination module determining a receiver of the message when the text is determined as the message expression, the message expression comprising the message; and
a transmission module transmitting the message to the receiver.

14. The apparatus of claim 13, further comprising:
a database maintaining at least one receiver expression and a destination address corresponding to the at least one receiver expression in association with the receiver,
wherein the transmission module identifies a receiver expression which is included in the message expression, reads the destination address associated with the receiver expression by referring to the database, and transmits the message to the read destination address.

15. The apparatus of claim 14, wherein the transmission module determines a type of the destination address, and transmits the message to a predetermined server associated with the destination address according to the type of the destination address.

16. The apparatus of claim 13, wherein the transmission module identifies a destination address which is included in the message expression, and transmits the message to the identified destination address.
